(19) United States
(12) Patent Application Publication
(10) Pub. No.: US 2008/0282537 A1
(43) Pub. Date: Nov. 20, 2008

(54) Wiring forming method of printed circuit board

(75) Inventors: Kwi-Jong Lee, Hwaseong-si (KR); Young-Il Lee, Anyang-si (KR); Byung-Ho Jun, Seoul (KR); Joon-Rak Choi, Gyeyang-gu (KR); In-Keun Shim, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/149,892

(22) Filed: May 9, 2008

(30) Foreign Application Priority Data
May 10, 2007 (KR) 10-2007-0045582

(51) Int. Cl. H01K 3/22

(52) U.S. Cl. 29/851; 29/846

(57) ABSTRACT

The present invention relates to a method for forming a wiring of a printed circuit board and more particularly, to a method including: preparing a base film; forming a wiring pattern with ink including metal nanoparticles on the base film by printing; and forming a wring by the induction heating of the base film on which the wiring pattern is formed. The method of the present invention which minimizes the thermal strain and thermal decomposition of a base film, provides an appropriate sintering process of wirings, shortens the manufacturing process, and exhibits excellent mechanical strength is provided by using the induction heating.

### CROSS-REFERENCE TO RELATED APPLICATION

This application claims the benefit of Korean Patent Application No. 10-2007-0045582 filed on May 10, 2007 with the Korea Intellectual Property Office, the contents of which are incorporated here by reference in their entirety.

### BACKGROUND

1. Technical Field

The present invention related to a method for forming a wiring of printed circuit board and more particularly, to a method for forming a wiring of printed circuit board by employing an induction heating method.

2. Description of the Related Art

Since trends and styles of electronic devices and information terminals are rapidly changing, a period of changing to new models is getting shorter and more various models are being developed. Thus, conventional methods for manufacturing products using lithography and ething not only cannot meet the situation of such rapid changings in models and styles since it requires forming masks but also causes serious environmental problems for waste water. Further, due to a great rise in the price of metal and organic-inorganic materials, the ink-jet technology, which ejects an exact amount of such materials to a portion where it is only needed, is come into the spotlight. Nano-sized metal particles, which are included in a wiring material, have been developed to form a fine wiring by using the ink-jet printing method.

Heating in a furnace at a high temperature has been widely used for sintering metal nanoparticles coated or printed on a glass or polymer substrate. When the furnace is used, the entire furnace should be heated. The heated furnace has to be maintained at a desired temperature from several minutes to several hours. In this case, it may cause energy consumption of the furnace and adversely affect the substrate coated with the metal nanoparticles by heating. When a substrate such as polymer having a glass transition temperature or strain temperature of lower than a sintering temperature of metal nanoparticles is used, it may limit the sintering temperature of metal nanoparticles. Here, the nanoparticles may not be completely sintered at such a low sintering temperature, which thus deteriorates the mechanical strength and the adhesion strength.

Further, a substrate including a fine wiring, which is thin and flexible and suitable for light and small electronic devices, is highly demanded. Examples of such a substrate are flexible printed circuit board, rigid-flexible printed circuit board and flexible multi layer printed circuit board, etc. A polymer film as a base film is suitable for such boards since it has many advantages. However, it has been still limited to be used since it cannot stand a high sintering temperature.

### SUMMARY

In order to resolve such problems associated with the above described conventional technologies, is a method for forming wirings of a printed circuit board provided which minimizes the thermal strain and thermal decomposition of a base film, provides an appropriate sintering process of wirings, shortens the manufacturing process, and exhibits excellent mechanical strength.

### BRIEF DESCRIPTION OF THE DRAWINGS

FIG. 1 is a graph illustrating the generation of inductive power according to frequency.

FIG. 2 is a flow chart illustrating a method for forming a wiring of a printed circuit board according to an embodiment of the present invention.

FIG. 3 illustrates a manufacturing process of a standard sample according to an embodiment of the present invention.

FIG. 4 illustrates an induction heating process according to an embodiment of the present invention.

FIG. 5 illustrates a method for determining the adhesion of a sample according to an embodiment of the present invention.

FIG. 6a is a SEM (Scanning Electron Microscope) image of the surface of a base film according to an embodiment of the present invention.

FIG. 6b is a SEM image of the interface of a base film according to an embodiment of the present invention.

FIG. 6c is a SEM image of the interface of a wiring according to an embodiment of the present invention.

FIG. 6d is a SEM image of the surface of a wiring according to an embodiment of the present invention.

FIG. 7a is a SEM image of the surface of a base film according to Comparative Example of the present invention.

FIG. 7b is a SEM image of the interface of a base film according to Comparative Example of the present invention.

FIG. 7c is a SEM image of the interface of a wiring according to Comparative Example of the present invention.

FIG. 7d is a SEM image of the surface of a wiring according to Comparative Example of the present invention.

### DETAILED DESCRIPTION

The present invention provides a method for forming a wiring of a printed circuit board, the method including: preparing a base film; forming a wiring pattern on the base film with ink including metal nanoparticles by printing; and performing an induction heating of the base film on which the wiring pattern is formed to form a wiring.

Here, the base film may be an organic film of which examples may be at least one chosen from polyimide film, polyester film, poly(propyleneoxide) film, epoxy film, phenol film, liquid crystalline polymer film, bismaleimide triazine film, cynate ester film, polyaramide film, polyfluoroethylene film, norbonene resin film and a combination thereof.

The organic film may include at least one chosen from silica (SiO₂), zirconia (ZrO₂), titania (TiO₂), barium titanate (BaTiO₃), glass wool and a mixture thereof in an amount of 30 to 70 wt. %.

Here, the metal nanoparticles may be at least one chosen from gold, silver, copper, platinum, lead, indium, palladium, tungsten, nickel, tantalum, bismuth, tin, zinc, aluminum, iron and an alloy thereof.

According to an embodiment of the present invention, the metal nanoparticles may have a diameter of 1 to 500 nm. Ink including the metal nanoparticles may be printed on a base film by the ink-jet method.

According to another embodiment of the present invention, the induction heating may be performed with passing a frequency of 10 to 900 kHz and may be performed for an entire circuit substrate or selectively for a part where a wiring is formed in the circuit substrate.

According to another embodiment of the present invention, the step of forming a wiring may be performed by a low temperature sintering while carrying the induction heating of the base film on which the wiring pattern is formed or the method may further include sintering at a low temperature before carrying the induction heating of the base film on which the wiring pattern is formed. The low temperature sintering is carried at a temperature of 150 to 350.

According to another embodiment of the present invention, the formed wiring may have a width of 10 μm to 10 cm.

Hereinafter, the method for forming a wiring of a printed circuit board according to certain embodiments of the invention will be described below in more detail with reference to the accompanying drawings, in which those components are rendered the same reference numeral that are the same or are in correspondence, regardless of the figure number, and redundant explanations are omitted. General properties of metal nanoparticles will be described first.

Metal nanoparticles of the present invention has a diameter of several tens nm to several hundreds nm.

The printed electronics field has been rapidly developed with the growth of nanomaterial technologies. The most valuable characteristic of nanomaterials is its low melting point, compared to bulk metals. When metal particles are reduced to less than nano-scale, the nano size effects are exhibited. Here, the term “the nano size effects” means that a number of physical and chemical properties suddenly change when the nanometer size range is reached. In case of a metal, nano-sized iron has an adiabatic stress 12 times higher than normal iron

In case of metal, when it is reduced to less than 100 nm, the nano size effects are exhibited, preferably less than 50 nm, more preferably less than 10 nm. For example, a melting temperature of silver (Si) is 961.9 but that of nano-sized silver of about 100 nm gets lowered and that of less than 10 nm is even lowered to 200 to 250.

When a diameter of metal particles is reduced enough to nano size, the surface area exposure becomes dominant and such a surface area exposure effects interfacial extension between particles. Thus, as the particle size is reduced, the melting point of a metal is lowered.

Buffat, et al. discloses the following formula 1 representing the phenomenon of melting point depression of nanoscale metal particles in Physical Review A, 13 (1976), 2287:

$$1 - θ = \frac{2}{{ρ}_{s} {Lr}_{s}} [ {γ}_{s} - {{γ}_{l} ( \frac{{ρ}_{s}}{{ρ}_{l}} )}^{\frac{2}{3}} ] \qquad [ Formula 1 ]$$

wherein, θ is Tₘ/T₀, ρₛ is solid density (kg/m³), ρ₁ is liquid density (kg/m³), L is latent heat (J/kg), rₛ is particle size (m), γₛ is solid surface tension, and γ₁ is liquid surface tension.

This melting point depression of nanoparticles allows the sintering at a low temperature of lower than 300° C. without deformation of a polymer substrate after printing or coating a nano-sized metal on the polymer substrate. Practically, silver nanoparticles has been attracted as an electrode material of printed electronics due to the sintering thereof at a low temperature of lower than 250° C. However, wirings using the silver nanoparticles are costly and have poor electric reliability such as silver migration.

Therefore, a demand for copper wirings has been continuously increased. But the copper wiring requires the sintering at a higher temperature due to high melting point unlike the silver wiring. It further has high resistivity through the low temperature sintering and exhibits deterioration of mechanical strength due to incomplete sintering. Therefore, there is a large demand for the sintering densification of high temperature sintering materials such as copper and for minimizing loss and deformation of a polymer substrate against heat.

High frequency induction heating is the process of heating an electrically conductive object by flowing induction current across the object to be heated in high frequency magnetic field of a coil by employing electromagnetic induction, which is a phenomenon that when a permanent magnet is taken in and out through the center of a coil shaped conductor, the magnetic field changes and current flows through the conductor,

This induction current is formed by eddy current which is swirling current to flow through an object and Joule heat is generated by hysteresis losses, so that heat is generated within a very short period of time. Heating with this generated heat is called as induction heating and when a high frequency current is used, it is called as a high frequency induction heating.

Since a high frequency current is used, magnetic flux and eddy current are centered toward the surface of an object due to the skin effect which is the tendency of a high frequency current to crowd toward the surface of an object and the proximity effect which is a phenomenon that the primary current is induced to an object to be heated and thus flows on the surface closer to a coil. Heat losses generated at this time such as eddy current loss and hysteresis loss are capable of heating the surface of an object.

This selective heating to a desired part of an object by centralizing energy allows efficient quick heating, so that productivity and processability may be improved. The heat efficiency is proportional to the square of the coil current and the number of coil turns and to the square root of the frequency, the effective permeability, and the specific resistance. Even though when the frequency is high, the heat efficiency is high, the frequency is lowered for a thick object since only the surface is heated due to the skin effect.

The skin effect may depend on the frequency and material as the following formula 2,

P=5.03\sqrt{ρ/fμ} [Formula 2]

wherein P is penetration depth, ρ is specific resistance, f is frequency, and μ is permeability.

Penetration depth is a depth that 90% of current is centralized from the surface of a conductive object to P. Thus, the current may flow from the surface of a conductive object to P depth. When heating is performed to an object by alternating frequencies, the heating value increases proportional to the square of the frequency at a low frequency and to the square root of the frequency at a temperature of higher than a certain frequency. This is because the magnetic force within the object is crossing and offsets each other when the frequency is much lower than the penetration depth.

The inflection point of frequency, where the generation of induction current changes and is a boundary of two characteristics, is called as critical frequency. The critical frequency fc is represented by the following formula 3,

$$Fc = 1.285 \times {10}^{8} \times \frac{e}{μ {a}^{2}} ( Hz ) \qquad [ Formula 3 ]$$

wherein a is a radius of an object to be heated, e is resistivity and μ is relative permeability.

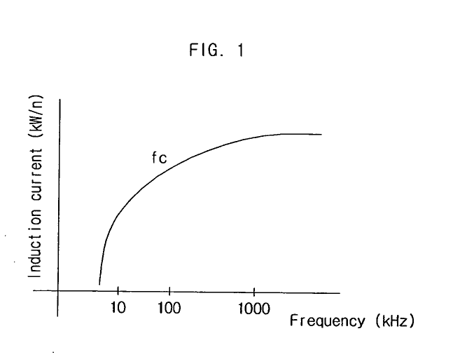

As shown in FIG. 1, a little change of frequency leads to a significant change of heating state at a frequency of less than critical frequency. On the other hand, when the frequency is too high, the heating efficiency is deteriorated with heavy heat releasing from the surface due to the skin effect. Thus, frequency which is 5 times higher than the critical frequency is used even if there is a little variation with a kind of heating sources. Therefore, the frequency in the induction heating is determined according to the skin effect and critical frequency which are relating to a kind and size of materials.

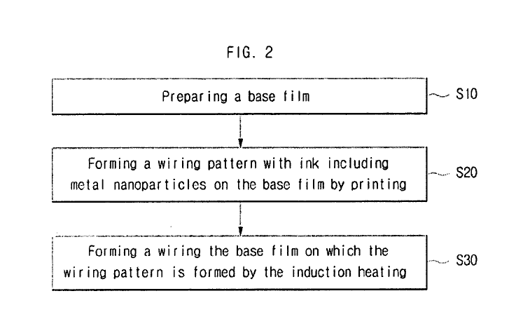

FIG. 2 is a flow chart illustrating a method for forming a wiring of a printed circuit board according to the present invention. Referring to FIG. 2, a method for forming a wiring of a printed circuit board according to the present invention includes: providing a base film of S10; forming a wiring pattern with ink including metal nanoparticles on the base film by printing of S20; and forming a wiring by the induction heating of the base film on which the wiring pattern is formed of S30.

A base film is first prepared in the method for forming a wiring of a printed circuit board according to the present invention in S10.

The base film may be an organic film and its examples include polyimide film, polyester film, poly(propyleneoxide (PPO) film, epoxy film, phenol film, liquid crystalline polymer (LCP) film, bismaleimide triazine (BT) film, cynate ester (CE) film, polyaramide film, polyfluoroethylene film or norbonene resin film but are not limited to them. Further, this base film may be used alone or as a combination of at least two.

Here, the organic film may include an inorganic compound of silica, (SiO₂), zirconia (ZrO₂), titania (TiO₂), barium titanate (BaTiO₃), glass wool or its combination of at least two in a content of 30 to 70 wt. %. When the inorganic compound is added less than 30 wt. %, it may not exhibit reduction in thermal expansion and increase in stiffness. On the other hand, when it is used more than 70 wt. %, the base film may be easily broken due to brittleness, so that it may not appropriate for a substrate.

A wiring pattern is then formed with ink including metal nanoparticles on the base film by printing in S20.

The metal nanoparticles may be gold, silver, copper, platinum, lead, indium, palladium, tungsten, nickel, tantalum, bismuth, tin, zinc, aluminum or iron but not be limited to them. The metal may be used alone or as a combination of at least two.

Here, the metal nanoparticles may have an average diameter of 1 to 500 nm, preferably 3 to 100 nm. When an average diameter of the metal nanoparticles is less than 1 nm, a content of an organic compound of ink including the metal nanoparticles is increased. On the other hand, when it is greater than 500 nm, the dispersibility of the metal nanoparticles is deteriorated.

An ink-jet printing method may be used to print the ink including the metal nanoparticles on the base film

A wiring is formed by the induction heating of the base film on which the wiring pattern is formed in S30.

The induction heating is performed at a frequency of 10 to 900 kHz, preferably 100 to 700 kHz. When the frequency is less than 10 kHz, heat generation is too poor, while when it exceeds 900 kHz, it may cause only minimum heating of the surface due to the skin effect.

According to an embodiment of the present invention, the induction heating may be applied for the entire circuit substrate or selectively for a part of the circuit substrate. According to another embodiment of the present invention, a wiring may be formed by sintering at a low temperature while performing the induction heating of the base film on which the wiring pattern is formed, a wiring may be formed by further performing sintering at a low temperature before the induction heating, or a wiring may be formed by further performing sintering the wiring after the wiring is formed.

According to another embodiment of the present invention, the sintering temperature in the method for forming a wiring of a printed circuit board may be 150 to 350, preferably 180 to 300. When the sintering temperature is lower than 150, the wiring pattern may not be sintered, while when it is higher than 350, the organic compound may be decomposed.

According to further another embodiment of the present invention, a wiring width of the formed wiring may be 10 μm to 10 cm, preferably 20 μm to 500 μm. When the wiring width is less than 10 μm, minimum heating with a high frequency and forming circuit by using the ink-jet method may be difficult. On the other hand, when it is greater than 10 cm, it may not be suitable for the substrate wiring.

The method for forming a wiring of a printed circuit board has been described with reference to the flow chart. Hereinafter, adhesion and interfacial shape between the base film of the printed circuit board of the present invention and the metal wiring will be described in detail by given examples.

### EXAMPLE 1

Adhesion strength between a base film and a metal wiring is determined and a picture of the base film and the metal wiring is taken with a scanning electron microscope (SEM) to provide the effect of the induction heating to the adhesion between a base film and a metal wiring and the shape of the base film and the metal wiring after the adhesion test is performed.

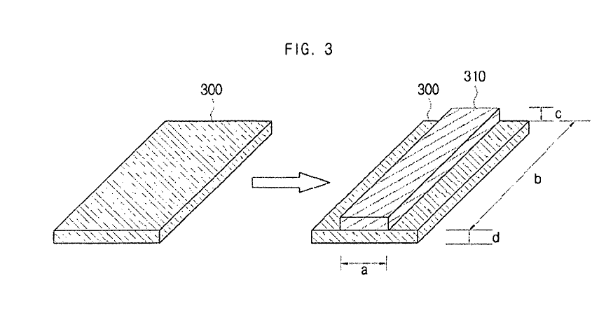

As shown in FIG. 3, a copper wiring pattern 310 having 1 cm×10 cm×10 μm of width (a)×length (b)×thickness (c) was printed on the bismaleimide triazine resin film (BT film) 300 with ink including copper nanoparticles having an average size of 20 nm by the ink-jet method.

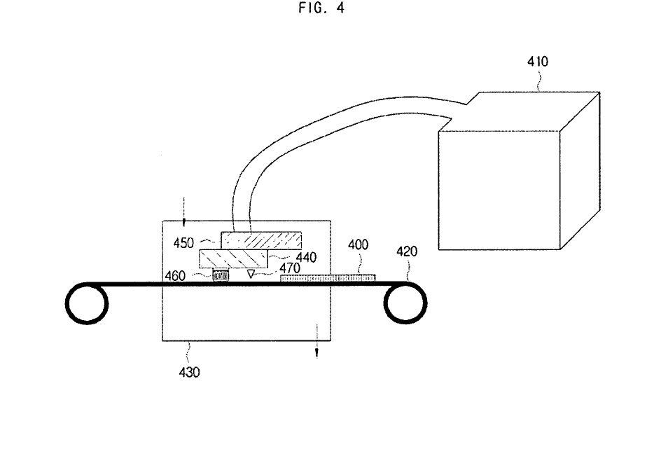

As shown in FIG. 4, after drying the copper wiring pattern 310 formed on the base film, a induction heating furnace 430 connected with a high frequency oscillator 410 was passed at an operation frequency of 500 kHz by using a conveyor belt 420. Nitrogen, argon, oxygen, hydrogen, air, organic acid gas or alcohol gas, etc. may be injected to the induction heating furnace 430 through a injection hole and air was used in this Example.

The heating part 440 could be selected from a probe microphone type 470 which is suitable for the induction heating of a small portion of the circuit substrate, where the wiring is formed, along with the area to be heated and a loop type which is suitable for the entire circuit substrate. In this Example, the probe microphone type heating part was used for the induction heating of the small portion including the copper wiring pattern of the printed circuit board 400 and for sintering with heat instantaneously generated to form a wiring of the printed circuit board. Its adhesion was determined and summarized in Table 1.

TABLE 1

| | Ave. diameter | | | |
|---|---|---|---|---|
| | of copper | | Operation | Adhesion |
| | nanoparticles | | frequency | strength |
| | (nm) | Induction heating | (kHz) | (kN/m) |
| Example 1 | 20 | Induction heating | 500 | 0.3 |
| Example 2 | 5 | Induction heating | 500 | 0.4 |
| Comparative | 5 | — | — | 0.1 |
| Example | | | | |

### EXAMPLE 2

As shown in FIG. 3, a copper wiring pattern 310 having 1 cm×10 cm×10 μm of width×length×thickness was printed on the bismaleimide triazine resin film (BT film) 300 with ink including copper nanoparticles having an average size of 5 nm by the ink-jet method.

Since the copper nanoparticles having an average size of 5 nm contained 15 to 20 wt. % of an organic compound, the heat treatment at a low temperature was necessary before the induction heating to reduce the content of the organic compound. Thus, after the heat treatment at 180° C. and the drying process of the copper wiring pattern 310 which was formed on the base film, a induction heating furnace 430 connected with a high frequency oscillator 410 was passed at an operation frequency of 500 kHz by using a conveyor belt 420 as shown in FIG. 4.

In this Example, the probe microphone type heating part was used for the induction heating of the small portion including the copper wiring pattern of the printed circuit board 400 and for sintering with heat instantaneously generated to form a wiring of the printed circuit board. Its adhesion was determined and summarized in Table 1. Pictures of the wiring and the base film of the sample used for the adhesion test were taken with a SEM.

### COMPARATIVE EXAMPLE

As shown in FIG. 3, a copper wiring pattern 310 having 1 cm×10 cm×10 μm of width×length×thickness was printed on the bismaleimide triazine resin film (BT film) 300 with ink including copper nanoparticles having an average size of 5 nm by the ink-jet method.

The copper nanoparticles having an average size of 5 nm contained 15 to 20 wt. % of an organic compound and a wiring of the printed circuit board was formed by sintering at a conventional furnace at a temperature of 250° C. Its adhesion was determined and summarized in Table 1 and the interfacial picture of the sample used for the adhesion test was taken with a SEM.

Adhesion Strength of the Base Film and the Wiring of the Printed Circuit Board

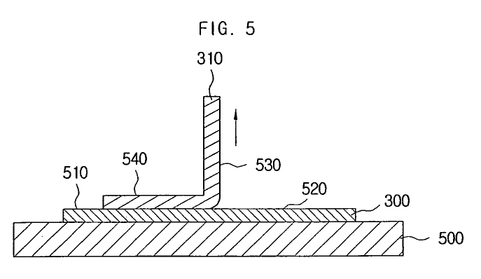

As shown in FIG. 5, the printed circuit board 300 on which the wiring formed at the conventional sintering furnace or that formed by the induction heating process was fixed at a supporting part 500 of a universal tensile machine (UTM) and each adhesion strength was determined according to the IPC TM-650 2.4.8 test method. The result was summarized in Table 1.

The adhesion when the induction heating was performed with using the copper nanoparticles having 20 nm as in Example 1 was 0.3 kN/m and the adhesion with the copper nanoparticles having 5 nm as in Example 2 was 0.4 kN/m as shown in Table 1. It is noted that the adhesion in Example 1 and Example 2 including the induction heating in the method for forming a wiring of a printed circuit board is 4 and 3 times better, respectively, than that in Comparative Example including the conventional sintering.

Shape of the Base Film and Wiring Shown in SEM Images

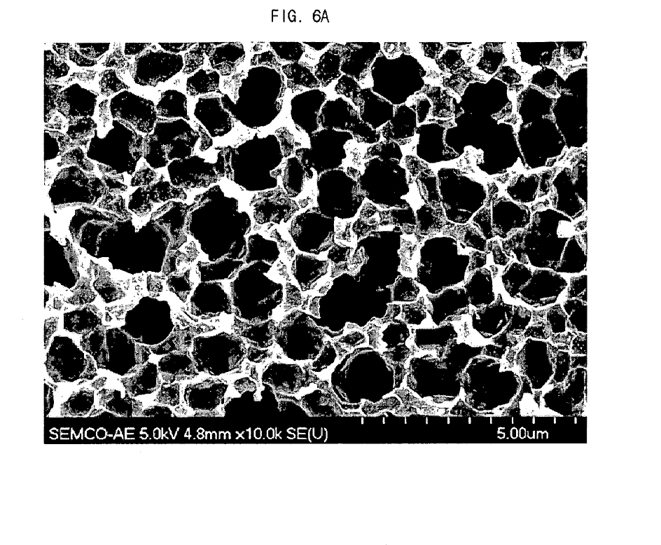

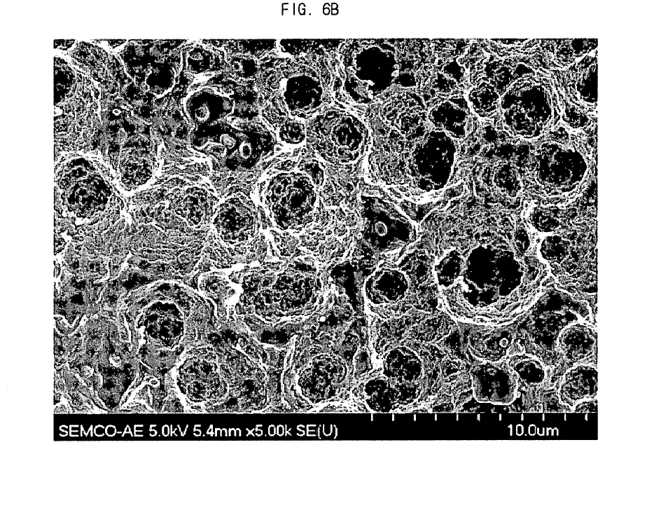

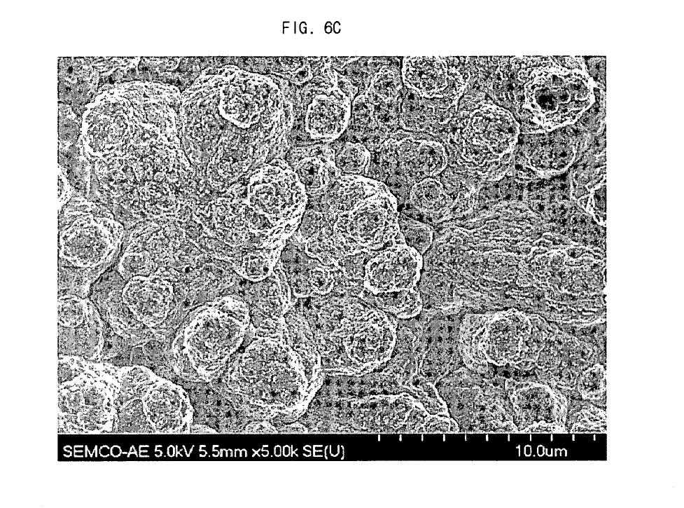

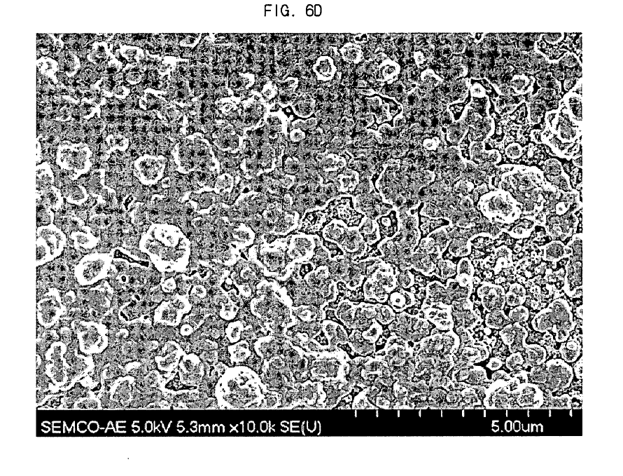

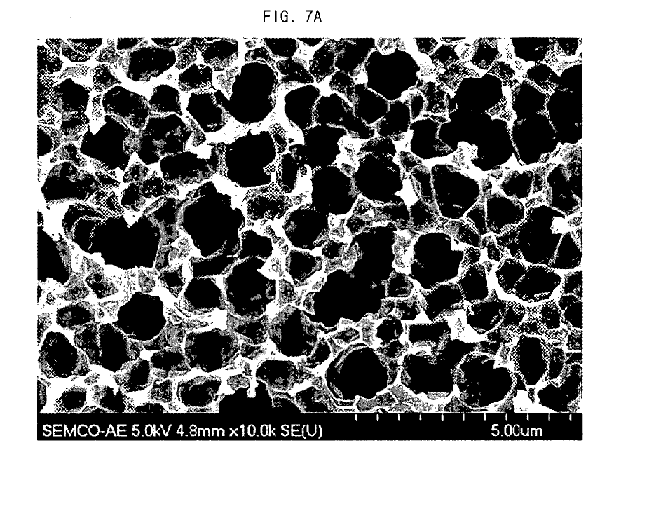

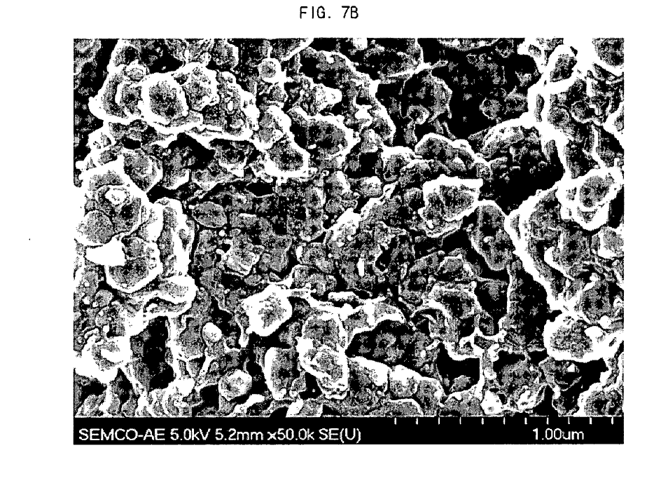

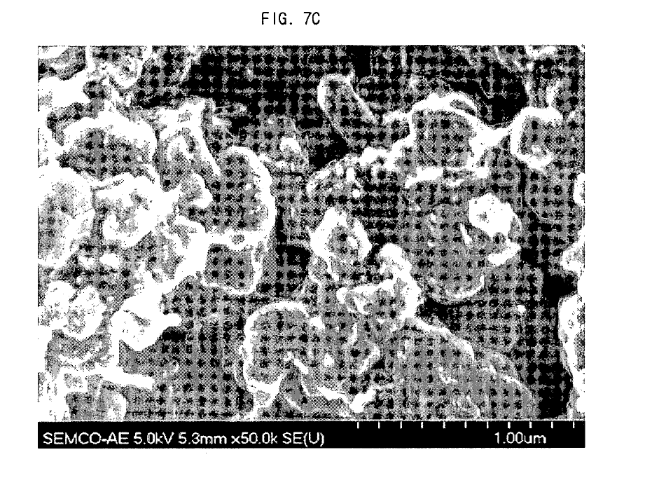

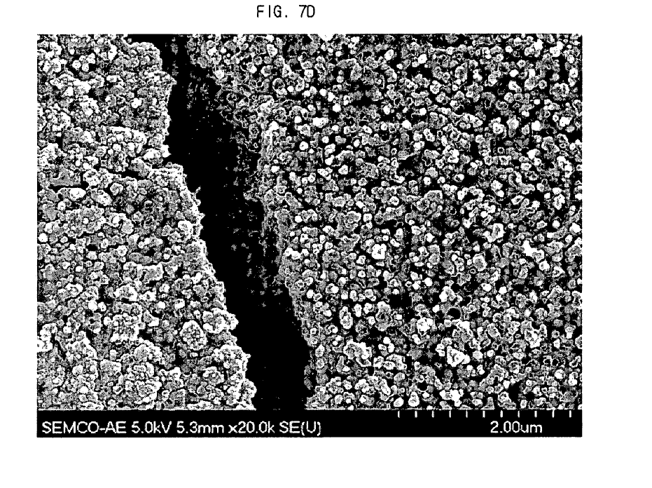

FIG. 6 and FIG. 7 are SEM images of the base film and the wiring of the printed circuit board formed by the method of the present invention and by the conventional method, respectively, in which the printed circuit board has been used for the adhesion test.

A portion where the base film and air are contacted is defined as a base film surface 510 and a portion where the base film and the wiring as a metal nanoparticle sintering layer are contacted or were contacted is defined as a base film interface 520 for describing simply and clearly Example and Comparative Example. A portion where the wiring and air are contacted is defined as a wiring surface 540 and a portion where the wiring and the base film are contacted or were contacted is defined as a wiring interface 530.

It is noted that FIG. 6a which is an image of the base film surface 510 of Example 2 of the present invention and FIG. 6b which is an image of the base film interface 520 of Example 2 of the present invention show similar surface shape. If destruction is caused according to the interface, shape of the base film before the wiring is formed is maintained. Thus, it is noted that destruction has been caused between the base film interface 520 and the copper wiring interface 530.

FIG. 7a which is an image of the base film surface 510 of Comparative Example sintered in the conventional sintering furnace and FIG. 7b which is an image of the base film interface 520 of Comparative Example sintered in the conventional sintering furnace show different surface shape each other. If the sintering of the wiring pattern including copper nanoparticles is not enough densified, cracks inside the wiring may occur and destruction may be thus caused. As shown in FIG. 7b, it is noted that destruction is caused not between the base film interface 520 and the copper wiring interface 530 but inside the wiring which is a nanoparticle sintering layer since a part of the metal nanoparticle sintering layer is remained in the base film interface 520.

It is noted that the wiring of Example 2 is sintered closely as shown in FIG. 6d, while crack is caused with the wiring of Comparative Example as shown in FIG. 7d. As described above, the destruction during the adhesion test is caused between the base film interface and the wiring in case of Example 2 which has no cracks, while the destruction is caused inside the wiring in case of Comparative Example which has cracks.

Referring to FIG. 6c and FIG. 7c, when the wiring interface of Example 2 and that of Comparative Example after the adhesion test is performed are compared each other, it is noted that the wiring interface of Comparative Example is rougher than that of Example. The reason may be that the wiring interface of Comparative Example has cracks and the sintering densification is not sufficiently achieved.

Therefore, the method for forming a wiring of a printed circuit board of the present invention using the induction heating prevents the formation of cracks in the wiring since the sintering densification is improved, so that the adhesion strength between the wiring and the base film is more than 3 times better than that in Comparative Example.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A method for forming a wiring of a printed circuit board comprising:
preparing a base film;
forming a wiring pattern with ink including metal nanoparticles on the base film by printing; and
forming a wring by the induction heating of the base film on which the wiring pattern is formed.

2. The method of claim 1, wherein the base film is an organic film.

3. The method of claim 2, wherein the organic film is one selected from the group consisting of polyimide film, polyester film, poly(propyleneoxide) film, epoxy film, phenol film, liquid crystalline polymer film, bismaleimide triazine film, cynate ester film, polyaramide film, polyfluoroethylene film, norbonene resin film and a combination thereof.

4. The method of claim 3, wherein the organic film includes one selected from the consisting of silica (SiO₂), zirconia (ZrO₂), titania (TiO₂), barium titanate (BaTiO₃), glass wool and a mixture thereof in an amount of 30 to 70 wt. %.

5. The method of claim 1, wherein the metal nanoparticles is at least one selected from the group consisting of gold, silver, copper, platinum, lead, indium, palladium, tungsten, nickel, tantalum, bismuth, tin, zinc, aluminum, iron and an alloy thereof.

6. The method of claim 1, wherein the metal nanoparticles has an average diameter of 1 to 500 nm.

7. The method of claim 1, wherein the printing ink including the metal nanoparticles on the base film is performed by an ink-jet printing method.

8. The method of claim 1, wherein the induction heating is performed with a frequency of 10 to 900 kHz.

9. The method of claim 1, wherein the induction heating is performed to the entire circuit board.

10. The method of claim 1, wherein the induction heating is performed selectively to the portion where the wiring portion is formed on the circuit board.

11. The method of claim 1, wherein the step of forming the wiring is performed by sintering at a low temperature while performing the induction heating of the base film on which the wiring pattern is formed

12. The method of claim 1, further comprising sintering at a low temperature the base film on which the wiring pattern is formed before the induction heating.

13. The method of claim 1, further comprising sintering at a low temperature the wiring after the step of forming the wiring.

14. The method of any one of claims 11 to 13, wherein the sintering is performed at a temperature of 150 to 350° C.

15. The method of claim 1, wherein the wiring formed has a width of 10 μm to 10 cm.
